(19) United States
(12) Patent Application Publication
(10) Pub. No.: US 2015/0187019 A1
(43) Pub. Date: Jul. 2, 2015

(54) SYSTEMS AND METHOD FOR AUTONOMOUS VEHICLE DATA PROCESSING

(71) Applicant: HARTFORD FIRE INSURANCE COMPANY, Hartford, CT (US)

(72) Inventors: Steven J. Fernandes, West Hartford, CT (US); Paul Brendan Olson, Hartford, CT (US); Pankaj Prakash, Rocky Hill, CT (US)

(73) Assignee: HARTFORD FIRE INSURANCE COMPANY, Hartford, CT (US)

(21) Appl. No.: 14/518,750

(22) Filed: Oct. 20, 2014

Related U.S. Application Data
(63) Continuation-in-part of application No. 14/145,142, filed on Dec. 31, 2013.

(51) Int. Cl. G06Q 40/08

(52) U.S. Cl. CPC G06Q 40/08

(57) ABSTRACT

A system configured to determine an insurance premium associated with an account that covers a vehicle including an autonomous feature and a driver comprising a computer memory that stores biographical information including information regarding the autonomous feature; a processor that receives information associated with telematics data associated with the vehicle, concerning use of the vehicle and the autonomous feature; the processor further configured to determine discrete segments of use by the vehicle, and to determine a driver signature associated with each of the discrete segments of use; the processor further configured to generate a driver risk assessment responsive to the one of the discrete segments of use; the processor further configured to calculate pricing information based on the risk assessment and the biographical information; and a transmitter configured to transmit the pricing information to a user device.

### CROSS REFERENCE TO RELATED APPLICATION

This application is a continuation-in-part of U.S. patent application Ser. No. 14/145,142, filed Dec. 31, 2013, which is incorporated by reference as if fully set forth.

### BACKGROUND

Auto insurance underwriting is the process by which insurance companies determine whether to offer insurance coverage, whether to renew insurance coverage, and to determine the pricing of any coverage that is offered. Insurance pricing may be based on a rate which may then be adjusted based on discounts, credits, penalties and other adjustments. For example, a driver may be given a discount based on the driver's experience and/or year driving without an accident. The final premium may be based on the determined risk factors associated with the driver, vehicle, laws/regulations, and other business factors.

Insurance pricing is typically derived using correlative data as a proxy for driving behavior. The proxies, such as age, driving experience, occupation, etc. may be derived from actuarial determined data. The pricing can vary depending on many factors that are believed to have an impact on the expectation of future claims and any cost associated with such future claims.

Generally, the three major factors in assessing risk may be: 1) coverage; 2) vehicle; and 3) driver. The coverage may determine the type and amount for which the insurance company may be responsible. The vehicle and driver may be important based on the statistical data that may indicate that a college educated professional driving a Lamborghini may not pose the same risk as a male high school student driving a station wagon. Further, there may be autonomous aspects of the car that factor into the statistical data.

In determining the pricing, the insurance company may determine the vehicle and coverage with some level of certainty. For example, the insurance company is provided with the vehicle manufacturer, model, age, value (and possibly service history) for which coverage is being requested. The insurance company may also determine the pricing for the type of coverage, (e.g. liability, collision, comprehensive, personal injury protection, and uninsured motorist protection), that is being purchased.

However, the insurance company may have little data for identifying the amount of time a vehicle is being operated by a particular driver. For example, in a household with multiple drivers and multiple vehicles, neither the insurance company nor the customer may possess accurate information regarding amount of time each vehicle is used by a particular individual. Further, those individuals are assessed based on correlative data, but this may not be accurate, e.g., not all high school students drive in a similar manner.

Additionally, the insurance company may want to account for the autonomous vehicle aspects and features, which may both decrease likelihood of damage, but also increase the cost of repairs when damage occurs.

Apparatus are described in greater detail using telematics data to identify driver signatures associated with the use of the vehicle. The system may further be configured to identify the driver associated with the driver signatures. This may allow the insurance company to determine risk associated with offering coverage and allow the insurance company to adjust pricing to reflect the actual usage of a particular vehicle. The apparatus described herein may use passive and non-passive techniques to identify a driver signature associated with use of the vehicle and a driver associated with each driver signature.

In addition, methods and apparatus are described in greater detail for accounting for vehicles that provide autonomous or semi-autonomous driving features to thereby reduce the reliance on a driver of a vehicle and accounting for the same in the insurance statistics.

### SUMMARY

A system configured to determine an insurance premium associated with an account that covers at least one vehicle including at least one autonomous feature and at least one driver comprising a computer memory that stores biographical information at least including information regarding the at least one autonomous feature; a processor that receives information associated with telematics data associated with at least one of the vehicle(s), concerning use of the at least one vehicle(s) and the at least one autonomous feature; the processor further configured to determine discrete segments of use by at least one vehicle(s), and to determine a driver signature associated with each of the discrete segments of use; the processor further configured to generate a driver risk assessment responsive to the at least one of the discrete segments of use; the processor further configured to calculate pricing information based at least in part on the at least one risk assessment and the biographical information; and a transmitter configured to transmit the pricing information to a user device or user transmission device.

A system configured to determine an insurance premium associated with an account that covers at least one vehicle and at least one driver comprising a computer memory that stores biographical information; a processor that receives information associated with telematics data associated with at least one of the vehicle(s), concerning use of the at least one vehicle(s); the processor further configured to determine discrete segments of use of at least one vehicle(s), and to determine a driver signature associated with each of the discrete segments of use; the processor further configured to generate a driver risk assessment responsive to the at least one of the discrete segments of use; the processor further configured to calculate pricing information based at least in part on the at least one risk assessment and the biographical information; and a transmitter configured to transmit the pricing information to a user device or user transmission device.

### BRIEF DESCRIPTION OF THE DRAWINGS

A more detailed understanding may be had from the following description, given by way of example in conjunction with the accompanying drawings wherein:

FIG. 1 shows an example system that may be used for determining driver signatures;

FIG. 2 shows a flow diagram for a method for determining pricing based on driver signatures associated with a vehicle;

FIG. 3 is an example web page for initiating a request for a vehicle insurance quote;

FIG. 4 is an example web page soliciting preliminary information regarding a request for a vehicle insurance;

FIG. 5 is an example web page soliciting additional preliminary information regarding a request for a vehicle insurance;

FIG. 6 is an example web page soliciting name and address information of the individual requesting an insurance;

FIG. 7 is an example web page soliciting vehicle information regarding a request for a vehicle insurance;

FIG. 8 is an example web page soliciting additional vehicle information regarding a request for a vehicle insurance quote;

FIG. 9 illustrates a system that may be used as a part of the system of FIG. 1 for identifying autonomous features of a vehicle and to account for the use of those features in determining risk and pricing information;

FIGS. 10A and 10B depict a vehicle that includes autonomous technology;

FIG. 11 illustrates a method to account for the various autonomous vehicle systems that may be included within a vehicle in pricing an insurance policy;

FIG. 12 is an example web page soliciting driver information regarding a request for a vehicle insurance;

FIG. 13 is an example web page soliciting additional driver information regarding a request for a vehicle insurance;

FIG. 14 is another example web page soliciting additional driver information regarding a request for a vehicle insurance;

FIG. 15 is an example web page soliciting driver history information regarding a request for a vehicle insurance;

FIG. 16 is an example web page soliciting a response from the user for registration to TrueLane® telematics program;

FIG. 17A shows an example configuration for determining a driver signature based on telematics data;

FIG. 17B shows an example configuration for determining a driver signature based on telematics data that accounts for a seasonality factor;

FIG. 18 shows an example electronic device that may be used to implement features described herein with reference to FIGS. 1-14; and

FIG. 19 shows a flow diagram for a method for determining pricing based on driver signatures associated with a vehicle.

### DETAILED DESCRIPTION

Disclosed herein are processor-executable methods, computing systems, and related technologies for an insurance company to determine driver signatures and to determine risk and pricing information based on those driver signatures, as well as insurance companies accounting for autonomous and semi-autonomous vehicle operation.

The present invention provides significant technical improvements to technologies for an insurance company to determine driver signatures and to determine risk and pricing information based on those driver signatures, as well as insurance companies accounting for autonomous and semi-autonomous vehicle operation technology. The present invention is directed to more than merely a computer implementation of a routine or conventional activity previously known in the industry as it significantly advances the technical efficiency, access and/or accuracy of technologies for an insurance company to determine driver signatures and to determine risk and pricing information based on those driver signatures, as well as insurance companies accounting for autonomous and semi-autonomous vehicle operation by implementing a specific new method and system as defined herein. The present invention is a specific advancement in the area of technologies for an insurance company to determine driver signatures and to determine risk and pricing information based on those driver signatures, as well as insurance companies accounting for autonomous and semi-autonomous vehicle operation by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance, client and/or vendor systems, networks and subsystems.

For example, an insurance customer may report that a first driver drives vehicle 1 100% of the time and a second and third driver split the use of vehicle 2. In this scenario, a high school student may be the first driver, and vehicle 1 may be an older used vehicle. The parents may be the second and third drivers, driving a new model high end vehicle. The high school student may drive the older vehicle to and from school, but use a parent's vehicle at night to meet friends. Alternatively, the high school student may frequently use the parent's vehicle on weekends. Whether that high school student is an excellent driver, initial pricing may be based upon the correlation of high school drivers and higher expected losses. In one example, an insurance company may generate pricing information on a worst case scenario, wherein the high school student drives the more expensive vehicle 100% of the time. In another example, the insurance company may generate pricing information based on a blended average of expected vehicle usage.

If an insurance company was able to determine how the vehicle is actually used, the insurance company may be able to apply causal data to the pricing analysis, and generate adjusted pricing information. Methods and apparatus described herein allow the insurance company to use telematics data and/or driver settings to determine driver signatures associated with each vehicle's use. These driver signatures may be used to determine the manner in which each vehicle is used. Further, these driver signatures may be used to determine the number of unique signatures associated with each vehicle. The system may assign an identity for each of the unique driving signatures for each vehicle. The system may further be configured to categorize driving segments as being driven by impaired drivers, unregistered drivers, or automatic (vehicle controlled) drivers. These driver signatures may be used for underwriting, pricing, claims, and fraud (Special Investigations Unit (SIU)) applications. This may include adjusting pricing information during scheduled insurance renewal periods as well as proactively adjusting pricing information based on exposure changes.

These exposure changes may include the addition or subtraction of a vehicle or drivers. The system may further be configured to determine that the individual or aggregate driver signatures have changed; this change may be compared to a threshold. Based on this comparison, the system may proactively adjust the pricing information.

In one embodiment, the driver signature information, determined based on telematics data, may be used to adjust insurance pricing information. For example, based on the usage of each vehicle, the system may adjust the insurance rate, provide a discount, or it may be used to credit or penalize the account. Because use of driver signatures may affect pricing, the uncertainty may cause individuals to be reluctant to join the program. Accordingly, the system may be configured to provide a discount to drivers that sign up for this program. Or it may be required for all vehicles for a household with high risk drivers. In another example, a user requesting a quote may be asked to provide telematics information prior to receiving a quote.

Autonomous vehicles may provide a decrease in accidents, while potentially driving up the cost of the accidents that remain. Other benefits of autonomous cars include increasing mobility for people who cannot drive today and solving parking issues in urban areas, since the cars can go off and park somewhere else. Insuring the vehicles that include these technologies may require alternate models from those used by the insurance industry today. Because the use of autonomous vehicles may decrease accident rates, the system may adjust the insurance rate, provide a discount, or it may be used to credit or penalize the account. Because these autonomous technologies are new and the idea of a car controlling itself is a bit unsettling to humans, individuals may be reluctant to use the autonomous features of the vehicle. An accounting may be performed to determine if autonomous features are actually enabled during the vehicle's use. Accordingly, the system may be configured to provide a discount to drivers that buy and enable autonomous features.

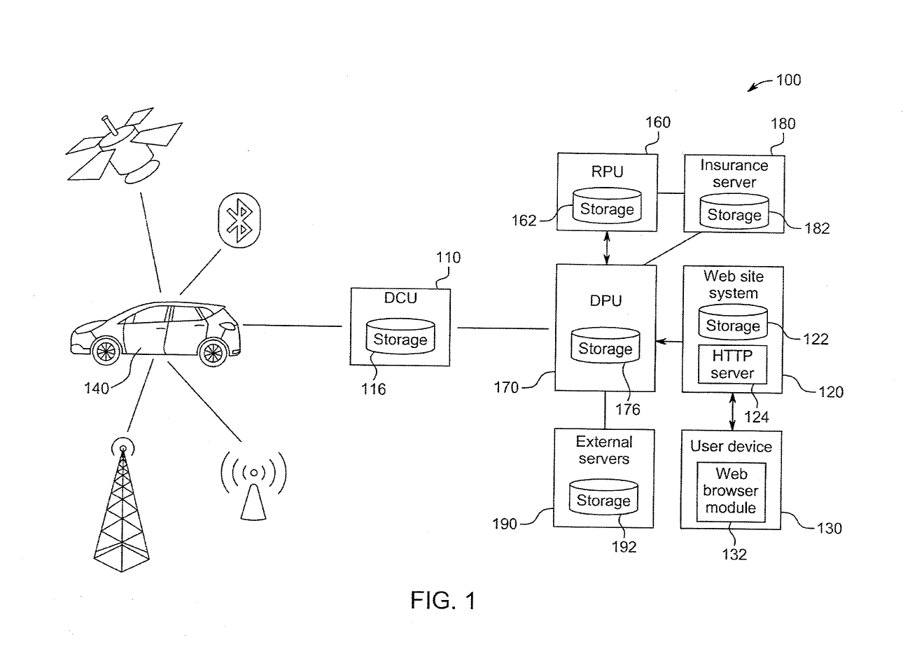

FIG. 1 shows an example system 100 that may be used for determining driver signatures and to use those driver signatures to determine risk and pricing information. The example system 100 includes a vehicle 140 equipped with one or more telematics devices (not pictured), for example a TrueLane® device. The telematics devices may further include smartphones, tablets, laptops, OEM connectivity devices and similar devices. The vehicle 140 may be in communication with multiple devices over different networks, including a satellite, a cellular station, a WI-FI hotspot, BLUETOOTH devices, and a data collection unit (DCU) 110. The DCU 110 may be operated by a third party vendor that collects telematics data or by the insurance company. The DCU 110 may include storage 116. The DCU 110 collects the telematics data and may then transmit the telematics data to a data processing unit (DPU) 170. The telematics data may be communicated to the DPU 170 in any number of formats. The telematics data may be transmitted as raw data, it may be transmitted as summary data, or it may be transmitted in a format requested by the DPU 170. The DPU 170 may also be configured to communicate with a risk and pricing unit (RPU) 160 including storage 162, internal insurance servers 180, including storage 182, and external servers 190 (e.g. social media networks, official/government networks), which are all connected by one or more networks.

The one or more telematics devices associated with the vehicle 140 may communicate with a satellite, Wi-Fi hotspot, BLUETOOTH devices and even other vehicles. The telematics devices associated with the vehicle 140 may report this information to the DCU 110. As will be described in greater detail hereafter, the DCU 110 may transmit a version of the telematics data to the DPU 170 which may be configured to consolidate a combination of stored biographical data, demographic data, and data available from external networks with the telematics data to generate driver signature information.

The web site system 120 provides a web site that may be accessed by a user device 130. The web site system 120 includes a Hypertext Transfer Protocol (HTTP) server module 124 and a database 122. The HTTP server module 124 may implement the HTTP protocol, and may communicate Hypertext Markup Language (HTML) pages and related data from the web site to/from a user device 130 using HTTP. The web site system 120 may be connected to one or more private or public networks (such as the Internet), via which the web site system 120 communicates with devices such as the user device 130. The web site system 120 may generate one or more web pages communication setting information, may communicate the web pages to the user device 130, and may receive responsive information from the user device 130.

The HTTP server module 124 in the web site system 120 may be, for example, an APACHE HTTP server, a SUN-ONE Web Server, a MICROSOFT Internet Information Services (IIS) server, and/or may be based on any other appropriate HTTP server technology. The web site system 120 may also include one or more additional components or modules (not depicted), such as one or more load balancers, firewall devices, routers, switches, and devices that handle power backup and data redundancy.

The user device 130 may be, for example, a cellular phone, a desktop computer, a laptop computer, a tablet computer, or any other appropriate computing device. The user device 130 may further be configured to operate as a telematics device. The user device 130 includes a web browser module 132, which may communicate data related to the web site to/from the HTTP server module 124 in the web site system 120. The web browser module 132 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 132 may implement Rich Internet Application (RIA) and/or multimedia technologies such as ADOBE FLASH, MICROSOFT SILVERLIGHT, and/or other technologies. The web browser module 132 may implement RIA and/or multimedia technologies using one or more web browser plug-in modules (such as, for example, an ADOBE FLASH or MICROSOFT SILVERLIGHT plug-in), and/or using one or more sub-modules within the web browser module 132 itself. The web browser module 132 may display data on one or more display devices (not depicted) that are included in or connected to the user device 130, such as a liquid crystal display (LCD) display or monitor. The user device 130 may receive input from the user of the user device 130 from input devices (not depicted) that are included in or connected to the user device 130, such as a keyboard, a mouse, or a touch screen, and provide data that indicates the input to the web browser module 132.

The example system 100 of FIG. 1 may also include one or more wired and/or wireless networks (not depicted), via which communications between the elements in the example system 100 may take place. The networks may be private or public networks, and/or may include the Internet.

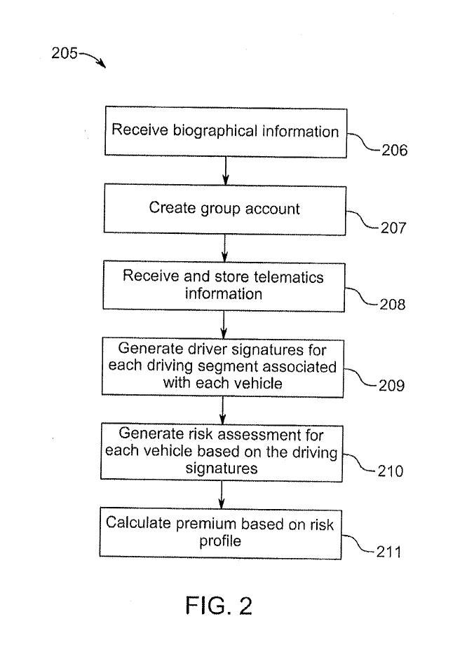

Each or any combination of the modules shown in FIG. 1 may be implemented as one or more software modules, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules may perform functionality described herein with reference to FIGS. 2-16.

FIG. 2 shows an example use case for method 205 for determining driver signatures. The system 100 receives biographical information regarding the user (step 206). This information may include information (such as the number of family members, age, marital status, education, address information, number and type of vehicles). Based on this information, the system 100 may create a group account (step 207). The group account may include subaccounts for each vehicle, wherein each vehicle may have multiple drivers. For each vehicle, the system 100 may create a use profile. The use profile is based on the indicated amount of use of each vehicle, by each driver. The system 100 may use correlative data based on stored information (including historic driver data associated with each driver, statistical/demographic information, biographical data) and other actuarial factors to determine a risk assessment associated with insuring each vehicle. This risk assessment may include expected claims and/or losses associated with the vehicle. The system 100 may use this risk assessment to determine pricing information for the account. This initial risk assessment may be based on correlative data (i.e. using the biographic/demographic data as a proxy for actual driving behavior.) This may include driver risk assessment, vehicle risk assessment, policy risk assessment or any appropriate risk assessment. The risk assessment may be represented as a profile, a score (or set of scores) or similar information stored in a database. Once the system 100 has generated the group account, it may begin to receive and store the vehicles' telematics data (step 208). The system 100 may use software based algorithms to analyze received telematics data. For example, the system 100 may be configured to cluster certain driver characteristics in the telematics data to identify discrete segments of use associated with a particular driver signature. The system 100 may be configured to associate each of these driver signatures with a driver (known or unknown) (step 209). The system 100 may then categorize the usage of each vehicle based on these driver signatures. In one example, the system 100 may determine the amount of time each vehicle is used by driver signatures associated with known and unknown drivers. The system 100 may adjust the risk assessment associated with the vehicle based on the number of driver signatures identified as well as an analysis of the type of driving the driver signature indicates (e.g. aggressive, distracted, cautious, etc.) (step 210). The risk assessment, generated by the system 100, may be a risk profile associated with the vehicle or the driver.

Alternatively, the system 100 may be configured to generate an aggregate risk profile for the group of vehicles, without individually assessing each driver or vehicle. Based on these driver signatures, the system 100 may be configured to assess the risks associated with coverage based on causal data in addition to or instead of correlative data. The system 100 may use these risks to adjust the pricing information (step 211). The pricing information may be adjusted by adjusting the assessed rate, or providing the customer with a discount, a credit or a penalty. In another example, the pricing information may be adjusted by placing the vehicle or driver in a different rate category.

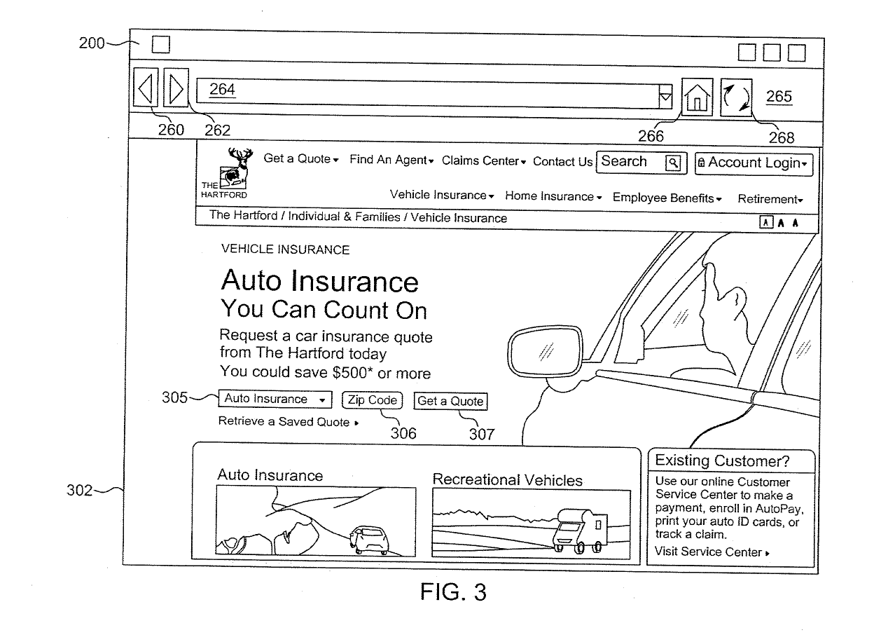

FIGS. 3-16 show example web pages that may be displayed by the web browser module 132. As will be described in detail below, the web pages may include display elements which allow the user of the user device 130 to interface with the system 100 and register or receive a quote for vehicle insurance. The web pages may be included in a web browser window 200 that is displayed and managed by the web browser module 132. The web pages may include data received by the web browser module 132 from the web site system 120. The web pages may include vehicle insurance information.

The web browser window 200 may include a control area 265 that includes a back button 260, forward button 262, address field 264, home button 266, and refresh button 268. The control area 265 may also include one or more additional control elements (not depicted). The user of the user device 130 may select the control elements 260, 262, 264, 266, 268 in the control area 265. The selection may be performed, for example, by the user clicking a mouse or providing input via keyboard, touch screen, and/or other type of input device. When one of the control elements 260, 262, 264, 266, 268 is selected, the web browser module 132 may perform an action that corresponds to the selected element. For example, when the refresh button 268 is selected, the web browser module 132 may refresh the page currently viewed in the web browser window 200.

FIG. 3 is an example web page 302 for initiating a request for a vehicle insurance quote. As shown in FIG. 3, the web page 302 may include questions accompanied by multiple input fields 305-307 in the form of drop down lists, text fields, and radio buttons. As the user provides input into the input fields 305-307, the web browser module 132 may store one or more data structures (“response data”) that reflect the selections made in the input fields 305-307. Further, as the selections are updated, the web browser module 132 may update the web page 302 to indicate additional or more specific questions that may be associated with the selections. If there are no errors in the transmission, the web browser module 132 is directed to a subsequent web page. While the example shown is for auto insurance, the methods and apparatus disclosed herein may be applied to any vehicle insurance, e.g. boats, planes, motorcycles etc. Also, while the examples are directed to family auto insurance, the methods and apparatus disclosed herein may be applicable to corporate insurance plans, or any policies covering vehicles.

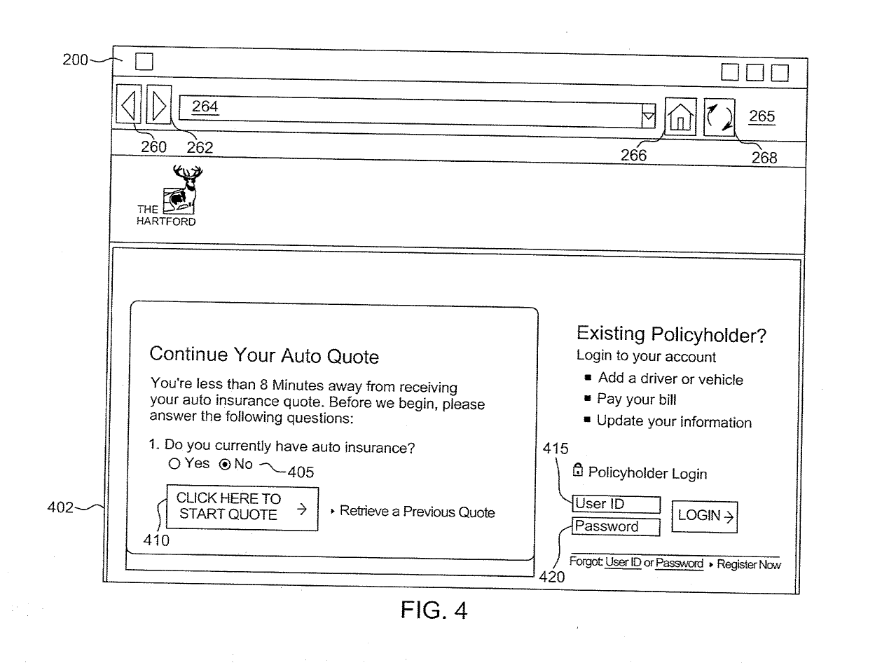

FIG. 4 is an example web page 402 soliciting preliminary information regarding a request for a vehicle insurance quote. As shown in FIG. 4, the web page 402 may include multiple input fields 405, 410, 415, and 420. As the user device 130 receives input for the input fields, the web browser module 132 may store one or more data structures (“response data”) that reflect the selections made in the input fields. Further, as the selections are updated, the web browser module 132 may update the web page 402 to indicate additional or more specific questions that may be associated with the selections. At any time, while viewing the web page 402 of FIG. 4, the user may enter user identification information in input fields 415 and 420, which accesses previously stored information associated with the user. If there are no errors in the transmission, the web browser module 132 is directed to a subsequent web page.

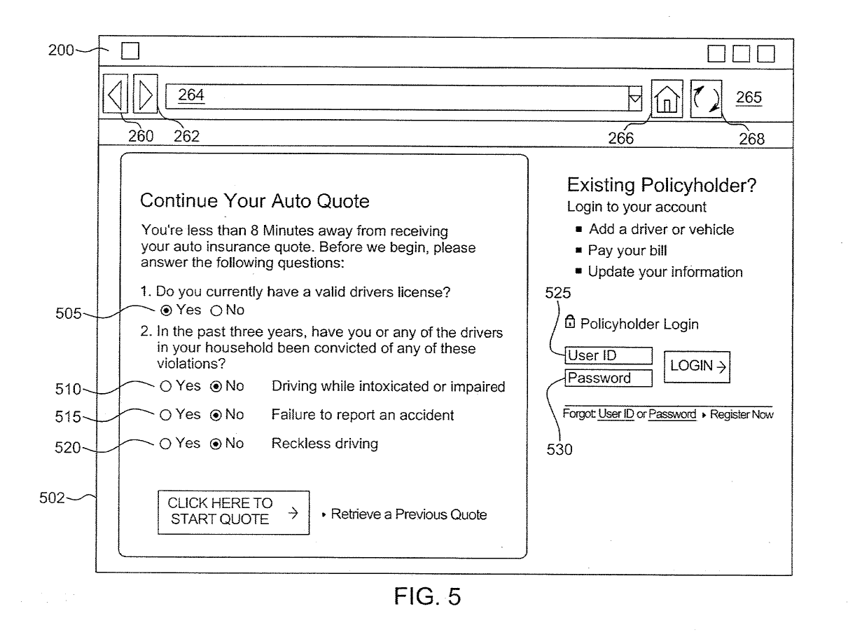

FIG. 5 is an example web page 502 soliciting additional preliminary information regarding a request for a vehicle insurance quote. As shown in FIG. 5, the web page 502 may include multiple input fields 505, 510, 515, 520, 525, and 530. As the user device 130 receives input for the input fields, the web browser module 132 may store one or more data structures (“response data”) that reflect the selections made in the input fields. Further, as the selections are updated, the web browser module 132 may update the web page 502 to indicate additional or more specific questions that may be associated with the selections. At any time, while viewing the web page 502 of FIG. 5, the user may enter user identification information in input fields 525 and 530, which accesses previously stored information associated with the user. Web page 502 solicits additional questions, for example, whether the user currently has a valid driver's license and whether the user or associated family has had any major driving violations. Such violations alert the system 100 that the user may be directed to a different insurance product. Additionally, while the telematics program is voluntary for some users, in one embodiment, a potential user may be eligible for additional products if they consent to using the telematics program, whereas previously they may have been disqualified. If there are no errors in the transmission, the web browser module 132 is directed to a subsequent web page.

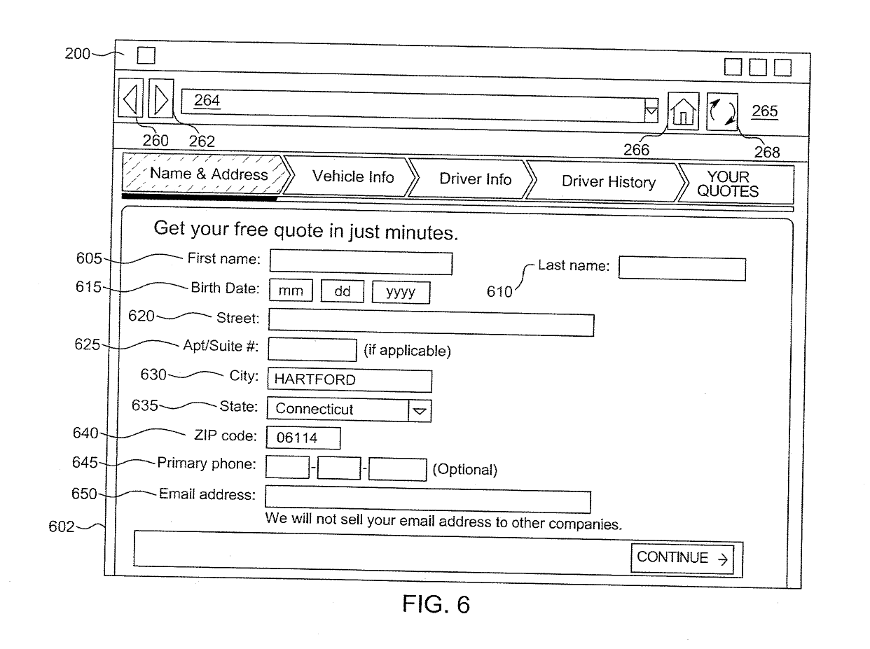

FIG. 6 is an example web page 602 soliciting name and address information of the individual requesting an insurance quote. As shown in FIG. 6, the web page 602 may include multiple input fields 605, 610, 615, 620, 625, 630, 635, 640, 645 and 650. As the user device 130 receives input for the input fields, the web browser module 132 may store one or more data structures (“response data”) that reflect the selections made in the input fields. Further, as the selections are updated, the web browser module 132 may update the web page 602 to indicate additional or more specific questions that may be associated with the selections. The questions displayed on web page 602 solicit questions regarding the contact information of the individual applying for insurance. As an example, the questions shown in FIG. 6 include: name, date of birth, address, phone number, and email address. If there are no errors in the transmission, the web browser module 132 is directed to a subsequent web page.

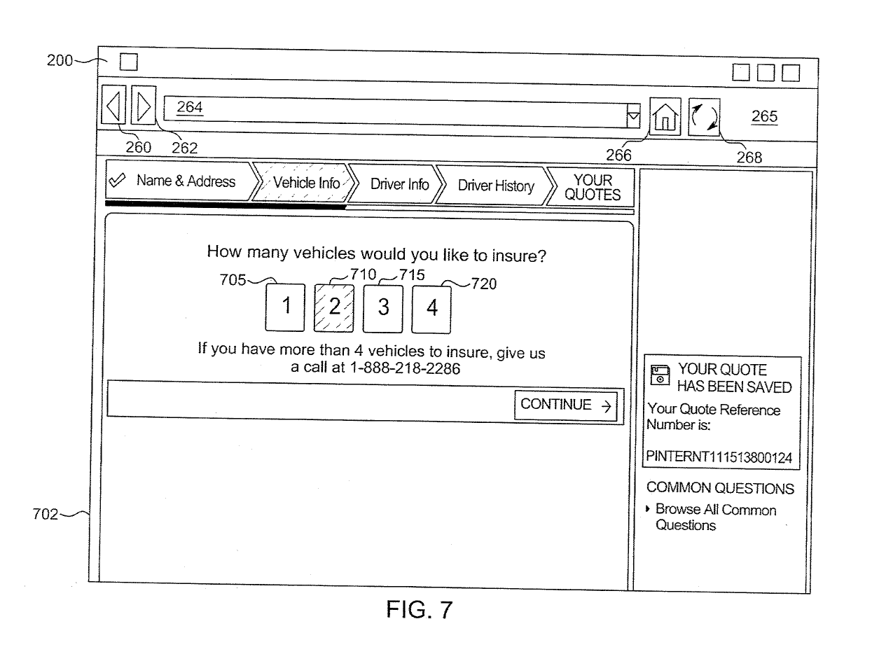

FIG. 7 is an example web page 702 soliciting vehicle information regarding a request for a vehicle insurance quote. As shown in FIG. 7, the web page 702 may include radio buttons 705, 710, 715, and 720. As the user device 130 receives input selecting a radio button, the web browser module 132 may store one or more data structures (“response data”) that reflect the selections made. Further, as the selections are updated, the web browser module 132 may update the web page 702 to indicate additional or more specific questions that may be associated with the selections. The question displayed on web page 702 solicits information regarding the number of vehicles for which insurance is being requested. While the example shown in FIG. 7 only allows four vehicles, this is as an example only. More or less vehicles may be allowed. If there are no errors in the transmission, the web browser module 132 is directed to a subsequent web page.

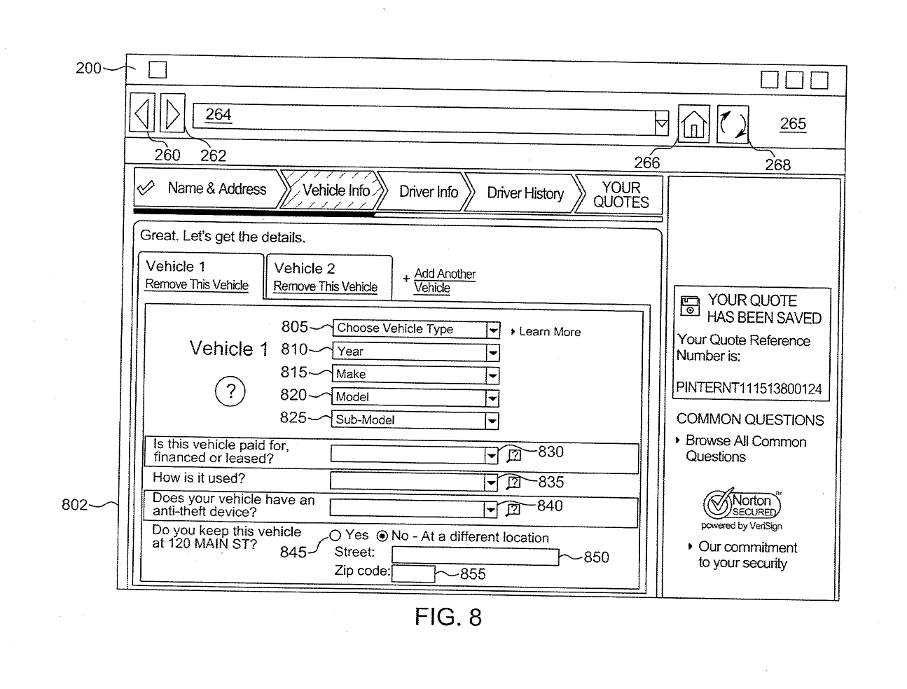

FIG. 8 is an example web page 802 soliciting additional vehicle information regarding a request for a vehicle insurance quote. As shown in FIG. 8, the web page 802 may include radio buttons 805-855, for example, radio buttons Choose Vehicle Type 805, Year 810, Make 815, Model 820, Sub-Model 825, is this vehicle paid for, financed or leased? 830, How Is It used 835, Does your vehicle have an anti-theft device? 840, Yes or No-At a different location 845, Street 850 and Zip code 855. As the user device 130 receives inputs, the web browser module 132 may store one or more data structures (“response data”) that reflect the selections made. Further, as the selections are updated, the web browser module 132 may update the web page 802 to indicate additional or more specific questions that may be associated with the input. The question displayed on web page 802 solicits information regarding when the user is requested to enter vehicle type, year, make, model, and other information. The user is also requested to enter information as to how the vehicle is paid for, how the vehicle is used, whether there is anti-theft equipment, and where the vehicle is stored. The web page 802 also includes tabs to add data for additional vehicles and to remove vehicles. If there are no errors in the transmission, the web browser module 132 is directed to a subsequent web page.

This information collected via the webpages as depicted in FIGS. 7 and 8, or otherwise collected, may include information regarding the autonomous or semi-autonomous features of the vehicle. While the term autonomous or semi-autonomous is being used herein, these terms are intended to cover at least any automated controlling or other operation of the vehicle or any vehicle subsystem. Many times these autonomous features may be identified as being installed in a vehicle by using the vehicle identification number (VIN). Other times such autonomous features may be added to the vehicle after-market, and are therefore not identified via the VIN. In such a situation, the information regarding the autonomous feature or features may be needed to be entered manually, or otherwise captured. Other methods of obtaining this information include partnerships with after-market installation companies and tracking companies such as CarFax®, for example.

By way of example, semi-autonomous vehicles may include such features in which the vehicle will take control of itself for either safety or convenience purposes, including cruise control, adaptive cruise control, stability control, pre-crash systems, automatic parking, and lane-keeping system, for example. Autonomous and semi-autonomous vehicles may represent a myriad of different levels of automated operation. For example, in the United States, the National Highway Traffic Safety Administration (NHTSA) has established an official classification system that is included herein to provide a complete picture of the scale of autonomous vehicle control.

Level 0: The driver completely controls the vehicle at all times.

Level 1—Individual vehicle controls are automated, such as electronic stability control or automatic braking.

Level 2—At least two controls can be automated in unison, such as adaptive cruise control in combination with lane keeping systems.

Level 3—The driver can fully cede control of all safety-critical functions in certain conditions. The car senses when conditions require the driver to retake control and provides a “sufficiently comfortable transition time” for the driver to do so.

Level 4—The vehicle performs all safety-critical functions for the entire trip, with the driver not expected to control the vehicle at any time. As this vehicle would control all functions from start to stop, including all parking functions, it could include unoccupied cars.

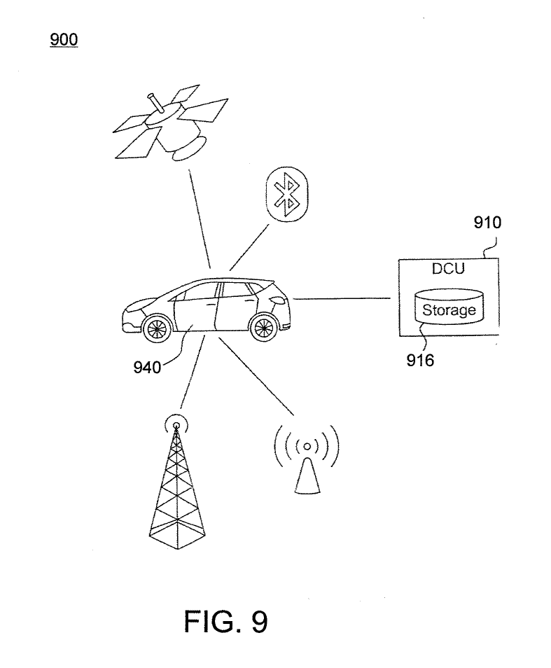

Referring to FIG. 9, there is illustrated a system 900 that may be used as a part of system 100 for identifying autonomous features of a vehicle and to account for the use of those features in determining risk and pricing information. System 900 is similar to system 100 described herein and incorporates many of the features of system 100. System 900 may be a part of system 100, used separately, or used in conjunction therewith. The example system 900 includes a vehicle 940 equipped with one or more telematics devices (not pictured), for example a TrueLane® device. The vehicle 940 may be in communication with multiple devices over different networks, including a satellite, a cellular station, a WI-FI hotspot, BLUETOOTH devices, and a data collection unit (DCU) 910. The DCU 910 may be operated by a third party vendor that collects telematics data or by the insurance company. The DCU 910 may include storage 916.

As will be described in greater detail hereafter, the DCU 910 may transmit information associated with autonomous features of the vehicle. This information may include autonomous features installed in the vehicle, features that are in use, and the mileage associated with such a use. The DCU 910 may include a black box that snaps data at a given time, such as at the time of an accident for example.

Vehicle 940 may allow for communication with other vehicles. For example, platooning of computer systems of a myriad of vehicles may occur.

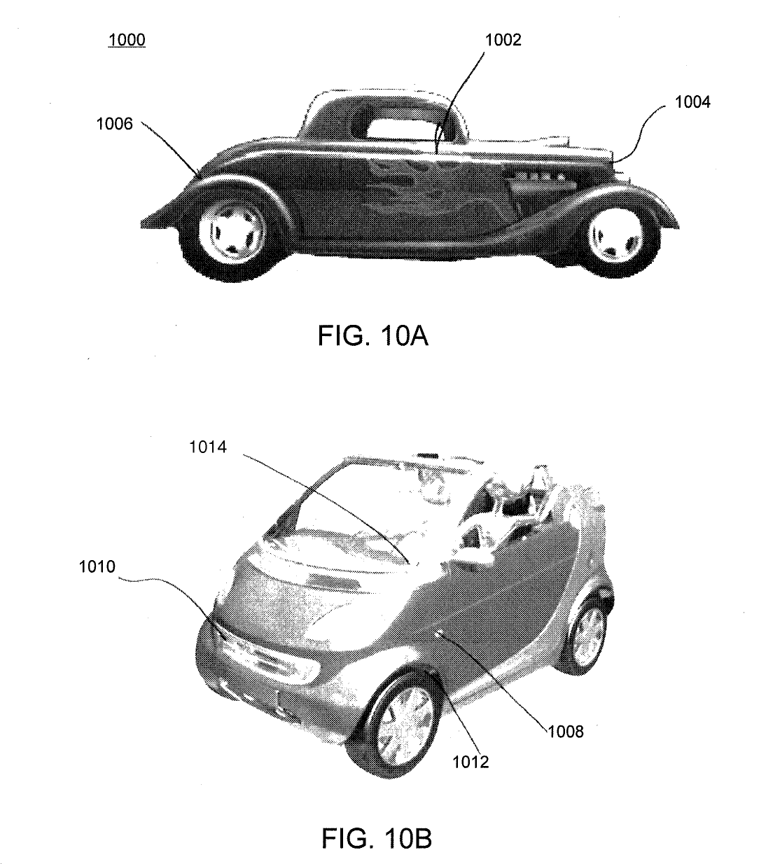

Referring now to FIGS. 10A and 10B, there is depicted a vehicle 1000 that includes autonomous technology. Adaptive cruise control 1002 may be included in the vehicle. Adaptive cruise control 1002 may include technology to automatically adjust the vehicle's 1000 speed to maintain a safe following distance as compared to the car immediately preceding the vehicle. Adaptive cruise control 1002 may use forward-looking radar, installed behind the grill of the vehicle 1000, to detect the speed and distance of the vehicle ahead of the vehicle 1000.

Vehicle 1000 may also include adaptive headlights 1004. Adaptive headlights 1004 may react to the steering, speed and elevation of the vehicle 1000 and automatically adjust to illuminate the road ahead. When the vehicle 1000 turns right, the headlights 1004 angle to the right. Turn the vehicle 1000 left, the headlights 1004 angle to the left. This is important not only for the driver of the vehicle 1000 with adaptive headlights, but for other drivers on the road as well. The glare of oncoming headlights can cause serious visibility problems. Since adaptive headlights 1004 are directed at the road, the incidence of glare is reduced. Adaptive headlights 1004 use electronic sensors to detect the speed of the vehicle 1000, how far the driver has turned the steering wheel, and the yaw of the vehicle 1000. The sensors direct small electric motors built into the headlight casing to turn the headlights 1004. Adaptive headlight 1004 may turn the lights up to 15 degrees from center, giving them a 30-degree range of movement, by way of example only.

Backup warning 1006 may also be equipped in vehicle 1000. Backup warning 1006 may include a camera system for use by the driver and also a warning system 1006 that provides a driver with sound and visual aids to alert the driver of dangers that are being approached while vehicle 1000 backs up.

Vehicle 1000 may also include a lane departure system 1008. Sensors for a lane departure 1008 may also be included in the side mirrors as well (not shown). Lane departure 1008 may prevent high speed accidents on highways and freeways. By warning the driver, or even taking automatic corrective actions, these lane departure systems 1008 are able to prevent many collisions and accidents. Generally, a lane departure system 1008 monitors the lane markings on the roadway, which sounds an alarm whenever vehicle 1000 starts to deviate from its lane. The driver can then take corrective action, which can prevent a run-off-road accident or a collision with another vehicle. Lane departure system 1008 may also include a more proactive version, often referred to as a lane-keeping system. Lane departure system 1008 may take action to keep the vehicle 1000 from drifting, if the driver does not respond to an initial warning.

Vehicle 1000 may also be equipped with forward collision warning systems 1010 and forward collision braking systems 1012. Forward collision warning systems 1010 may include collision warning and mitigation systems that detect potential collisions with slow moving or stationary objects in the vehicle's 1000 path, and either warn the driver or automatically take evasive action. Collision warning 1010 may use radar, laser or optical cameras in the vehicle's 1000 nose to detect objects in the vehicle's 1000 path and determine based on the closing speed (the difference in speed between the vehicle 1000 and the object ahead), and the system 1010 may determine if a collision is likely. Collision warning systems 1010 may alert the driver by either sounding an alarm, flashing a light on the instrument panel, vibrating the seat, or some combination of the three or another alerting technique. Collision systems 1010 may combine warnings with some sort of action, such as applying the brakes using the forward collision braking system 1012, for example. Some systems 1010, 1012 may provide steering assistance or prompts. Collision systems 1010, 1012 may also prepare vehicle 1000 for a collision (or its avoidance) by closing the windows, tightening the seat belts, or moving the seats into a position for optimum airbag protection. System 1010, 1012 may pre-charge the brakes, so that the driver gets maximum braking as soon as the brake-pedal is activated.

Vehicle 1000 may include parking assistance systems 1014. The systems 1014 may use a variety of sensors to determine the approximate size of the space between two parked vehicles, and then a built-in computer calculates the necessary steering angles and velocities to safely navigate vehicle 1000 into the parking spot. System 1014 may control the vehicle 1000 with little or no input from the driver.

Other autonomous vehicles 1000 may include technologies such as those described above. Autonomous vehicles may cover technologies from those technologies described herein all the way to steering wheel-less vehicles that operate in a completely autonomous fashion including vehicles such as level 4 vehicles described above.

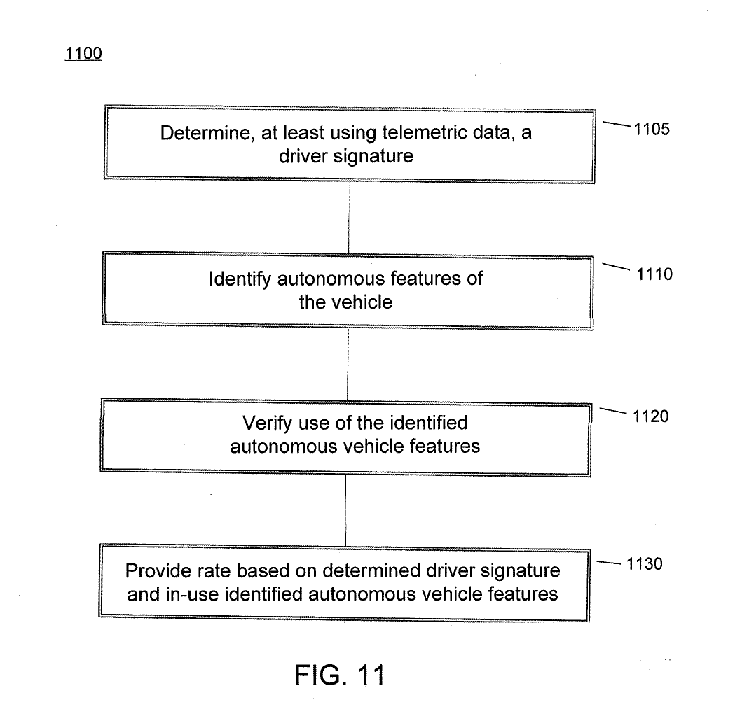

In order to account for the various autonomous vehicle systems that may be included within a vehicle in pricing an insurance policy for the vehicle, the method 1100 illustrated in FIG. 11 may be used. In step 1105, a determination may be made, as described herein, of a driver signature.

In step 1110, the autonomous features or systems of the vehicle may be identified. As described herein, this information may be collected via the webpages as depicted in FIGS. 7 and 8, or otherwise collected, such as manually entered or received via a third party like an after-market installation company or a tracking company such as CarFax®. Importantly, in step 1110, a determination is made regarding the features of the vehicle. That is, if the vehicle has autonomous features and if so which ones. If the features are present, where the features installed as stock features or added features installed by the dealer, or where the features added after market by an after market retailer or the owner of the vehicle.

Method 1100 may include a verification that the identified autonomous vehicle features are being used 1120. In step 1120, a determination is made regarding the use of the feature, i.e., was the feature on/off during use of the vehicle. A feature may be configured to be always “on.” Alternatively, a features use value may be determined from the telematics information as described herein. A proxy may be used for representing how much a feature may be “on.” For example, if an anti-locking breaking is installed on the car, verification of the fact that the anti-lock breaking system is operational (turned on) may be the initiator of the reduced insurance premium. For example, if the system is installed in the vehicle, but the driver (or other operator such as an owner) of the vehicle disables the system or otherwise turns the system off, the vehicle may not qualify for that respective discount while configured in this way. However, the fact that the autonomous features are included on the vehicle may still provide some discount, because for example owners of vehicles with autonomous features may be known to be safer, for example.

Method 1100 may provide a rate based on the driver signature (as discussed herein) and the in-use (including discount for having a vehicle with certain safety features even if the feature(s) are off) identified autonomous vehicle features 1130. This rate may be based on which types of autonomous features are used, how frequently the features are used, which driver the features displace, the combinations of features being used, and the like.

By way of example, a certain combination of autonomous features that are in use, such as forward collision breaking and backup braking, may be known to reduce accidents and may be combined to provide a larger rate reduction for the vehicle than potential other combinations of autonomous features. Each autonomous feature may have its use weighted in the ultimate calculation of premiums. The weight provided for a feature may be based on the amount of safety that the feature provides relative to the risk associated with the driving that is being performed. Some, or all, of the features may have the same weight when performing rate reduction calculations.

Further, autonomous features that take the place of drivers who are known to be particularly prone to accidents provide a further rate reduction with respect to those features that are replacing relatively safer drivers, for example. The statistics show that 92% of accidents are a result of driver error, and the use of autonomous features to replace as great a percentage of the human driver (particularly those where there is driver error) the greater the reduction in accidents.

Use of autonomous features during certain times of the day, and/or during certain types of driving may also increase the rate reduction. For example, use of features during lazy Sunday drives may provide one reduction level, while the use of the same features during rush hour on main roads may provide a higher rate reduction.

In modeling the use of autonomous features in a vehicle for providing insurance premiums, a multi-variate algorithm may be used. This algorithm may provide an exposure base and or a separate base rate, such as one base rate with the autonomous features and another base rate without the features. Liability may be credited as between the two rates based on use of the autonomous features. The autonomous algorithm may account for the environments that the vehicle is used in, as described herein, and the various configurations of the vehicle. Snapshots of claims based on accidents may be used to hone the algorithm, including those claims for a single crash.

In either of the two base rate scenarios or the algorithm, a weighted mileage may be deducted from the metric to arrive at the appropriate premium. By way of non-limiting example only, a vehicle having two autonomous features may be used. A first feature of the two is activated 66% of the time the vehicle is in use and provides a reduction of premium of 10%. The second of the two features is always on and is activated when the vehicle is being operated at less than 20 miles per hour. The second feature provides a 25% rate reduction for any miles meeting the speed criteria. For this particular example, the vehicle is operated at less than 20 miles per hour for 10% of the miles driven. In this case, the two features may operate cumulatively. The first feature provides a 6.6% rate reduction (66% of the time for a premium of 10%) and the second feature provides a 2.5% reduction (25% reduction 10% of the time). This vehicle may be eligible for a 9.1% discount on the premium of the vehicle.

While the present discussion has generally focused on vehicles, such as cars, for example, the concepts may be equally applicable to automobiles, boats, motorcycles, ships, commercial fleets, truck vehicles, and other insured items that may include autonomous features and other signatures associated with the insured items.

Additionally, the present system may be configured to cover a driver in a ride-share network. This may occur when a user of a vehicle drives the car of another person and/or may occur when there is a central car service, such as a Zipcar, for example. This may affect the pricing of premiums and coverage, and may be assessed using the tracking described herein. For example, the vehicle may be tracked to determine whether the vehicle owner is driving, the borrower driver is driving, and the amount of autonomous driving that is occurring. Specifically, during a given day, say the vehicle owner drives 75% of the miles and a borrower driver drives the other 25%. Of those miles, there is a calculated 20% autonomous driving ratio distributed equally between the two drivers. In this situation, the rating for the vehicle is the perfect autonomous driving score of 1 times the 20% that the autonomous driving occurs plus the owner's driving score times 60% (75% driving for 80% of the time) plus the borrower's score times 20 (25% driving for 80% of the time).

Further, the vehicle may provide autonomous features where the vehicle is connected to weather data and based on the weather data moves into the garage, for example. Alternatively, the vehicle may move to a safer location based on the weather data, for example. In either situation, the vehicle may monitor the weather information, and upon receipt of information that requires movement, may turn itself on and move as appropriate to aid in protecting the vehicle. Such a feature may reduce premiums on comprehensive by avoiding hail damage and other types of damage that occur as a result of weather accidents.

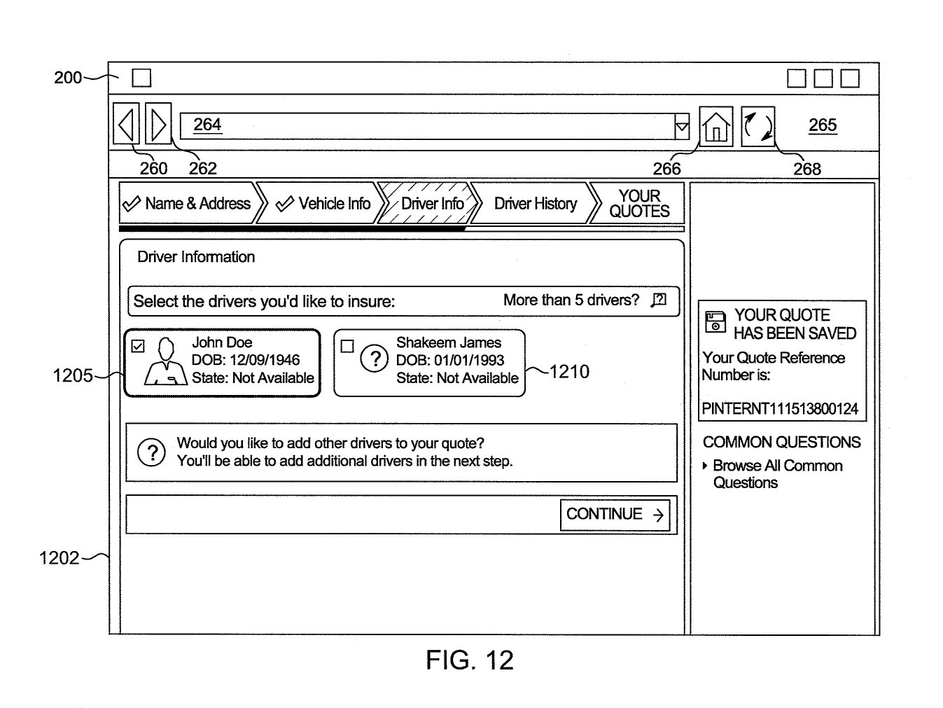

FIG. 12 is an example web page 1202 soliciting driver information regarding a request for a vehicle insurance quote. As shown in FIG. 12, the web page 1202 may include radio buttons 1205 and 1210. As the user device 130 receives inputs, the web browser module 132 may store one or more data structures (“response data”) that reflect the selections made. Further, as the selections are updated, the web browser module 132 may update the web page 1202 to indicate additional or more specific questions that may be associated with the input. The question displayed on web page 1202 solicits information regarding the identity of vehicle(s) for which insurance is being requested. Radio button 1205 for example, contains information that is generated based on the user information entered via web page 1202. Additionally, the system 100 may be configured to access data associated with the address information and determined suggested drivers, as shown in radio button 1210. If there are no errors in the transmission, the web browser module 132 is directed to a subsequent web page.

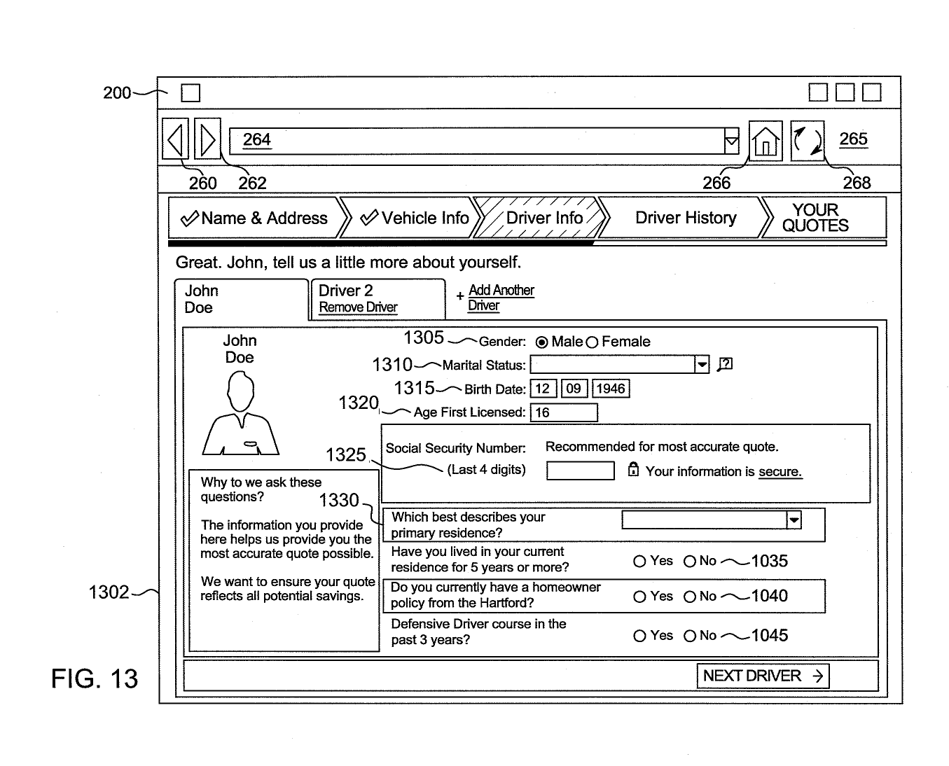

FIG. 13 is an example web page 1302 soliciting additional driver information regarding a request for a vehicle insurance quote. As shown in FIG. 13, the web page 1302 may include input fields 1305-1345, for example, input fields Gender 1305, Marital Status 1310, Birth Date 1315, Age First Licensed 1320, Social Security Number 1325, Which best describes your primary residence 1330, Have you lived in your current residence for 5 years or more 1335, Do you currently have a homeowner policy from the Hartford? 1340, and Defensive Driver course in the past 3 years? 1345. As the user device 130 receives inputs, the web browser module 132 button may store one or more data structures (“response data”) that reflect the selections made. Further, as the selections are updated, the web browser module 132 may update the web page 1302 to indicate additional or more specific questions that may be associated with the input. The question displayed on web page 1302 solicits information regarding the identity of vehicle(s) for which insurance is being requested. The system 100 may have access to additional database information to confirm or auto-fill information in the web page 1302. For example, based on the user's social security number, the system 100 may determine background information or confirm the identity. Web page 1302 allows the user to enter all of the additional drivers to be insured, along with their corresponding information. Additional information may also be requested, for example, for example, height, weight, cell phone number, employment information. The system 100 may further be configured to access information, for example from the local department of motor vehicles. This may enable the insurance company to access height and weight information, which may be used for driver signature identification as described in greater detail below. If there are no errors in the transmission, the web browser module 132 is directed to a subsequent web page.

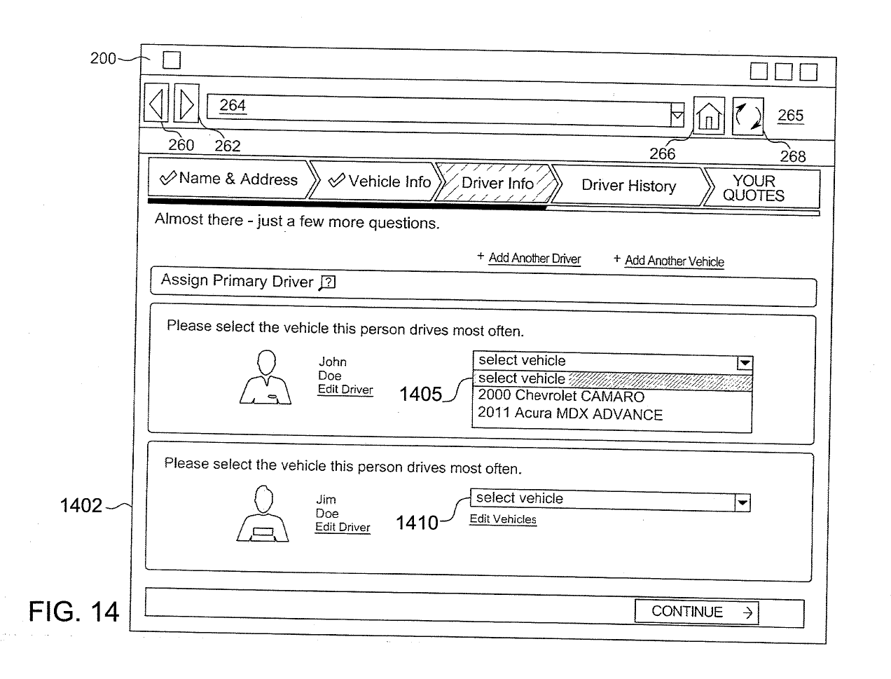

FIG. 14 is another example web page 1402 soliciting additional information regarding a request for a vehicle insurance quote. As shown in FIG. 14, the web page 1402 may include dropdown menus 1405 and 1410. As the user device 130 receives inputs, the web browser module 132 may store one or more data structures (“response data”) that reflect the selections made. Further, as the selections are updated, the web browser module 132 may update the web page 1402 to indicate additional or more specific questions that may be associated with the input. The question displayed on web page 1402 solicits information regarding the primary vehicles being driven by each driver. If there are no errors in the transmission, the web browser module 132 is directed to a subsequent web page.

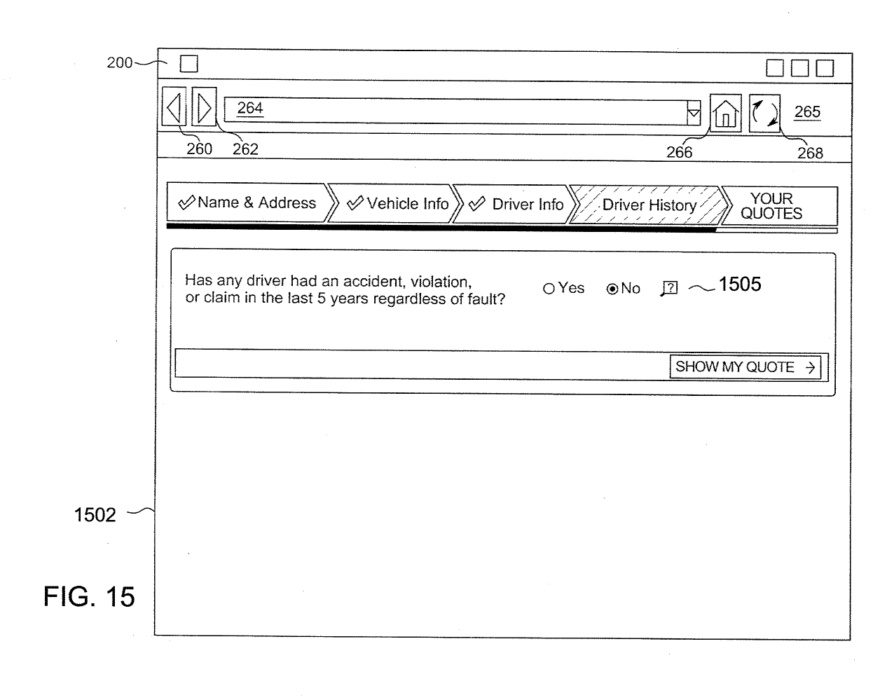

FIG. 15 is an example web page 1502 soliciting driver history information regarding a request for a vehicle insurance quote. As shown in FIG. 15, the web page 1502 may include radio button 1505. As the user device 130 receives inputs, the web browser module 132 may store one or more data structures (“response data”) that reflect the selections made. Further, as the selections are updated, the web browser module 132 may update the web page 1502 to indicate additional or more specific questions that may be associated with the input. The question displayed on web page 1502 solicits information regarding the driver history for each of the drivers. If there are no errors in the transmission, the web browser module 132 is directed to a quote.

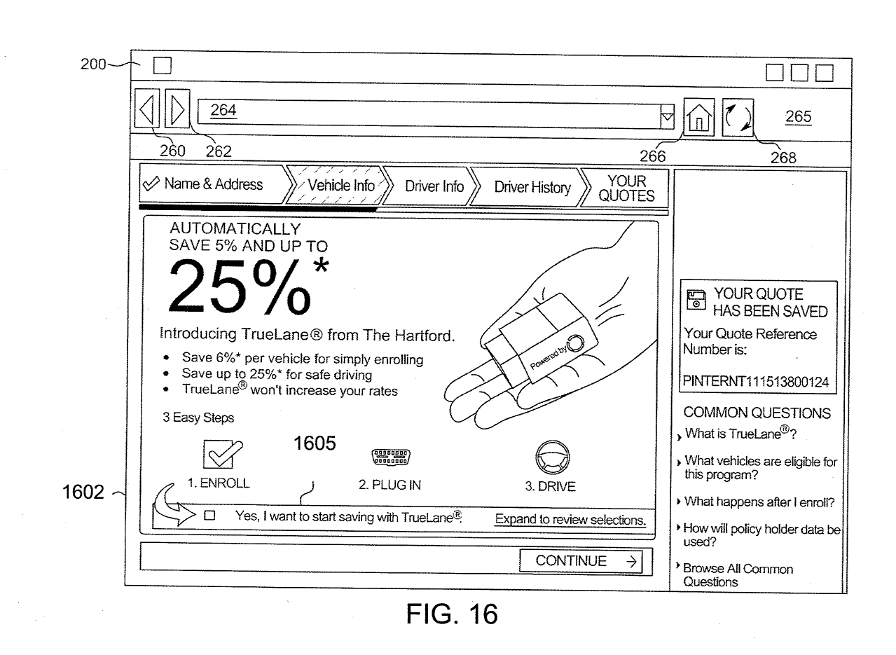

FIG. 16 is an example web page 1602 soliciting a response from the user for registration to TrueLane® telematics program. As shown in FIG. 16, the web page 1602 may include a radio button 1605. As the user device 130 receives inputs, the web browser module 132 may store one or more data structures (“response data”) that reflect the selections made. Further, as the selections are updated, the web browser module 132 may update the web page 1602 to indicate additional or more specific questions that may be associated with the input. Based on the previous answers supplied by the user, the system 100 determines whether the user is eligible for the TrueLane® discount. Alternatively, if the driver or vehicle is in a higher risk category, TrueLane® may be required in order to receive or maintain insurance coverage. The question displayed on web page 1602 confirms enrollment in the TrueLane® telematics program. If there are no errors in the transmission, the web browser module 132 is directed to a subsequent web page where a quote may be provided.

While the below examples describe a scenario wherein a new customer registers for insurance and then the system 100 adjusts the pricing information based on telematics data. The systems and methods described herein may be applied to current and former customers who are looking to renew their coverage. In this scenario, the biographical information and historical driver information may already be stored on the insurance server 180, and the DPU 170 may access this information directly.

During the registration phase, the system 100 receives biographical information about each of the vehicles and the expected drivers for each vehicle and the percentage each driver is expected to use each vehicle. This may be used as a baseline to create vehicle profiles.

The inside of vehicle 140, may include a plurality of electronics devices that may communicate information to the telematics device. The vehicle 140 may include a microprocessor and memory that may operatively connect to each individual electronic device. For example, there may be electronic devices associated with the seats, A/C units, global positioning satellite (GPS)/stereo system, DVD unit, and BLUETOOTH equipment. The microprocessor may also be in communication with the headlights, engine, traffic signals, rear view mirror, rearview cameras, cruise control, braking system and inner workings of a vehicle. There may also be additional devices such as multiple user devices 130 brought by passengers into a vehicle. The telematics device is configured to receive information from the electronics in the vehicle 140. For example, the telematics device is configured to receive data concerning, speed, braking, location, seat settings, lane changes, radio volume, window controls, vehicle servicing, number of cellular devices in a vehicle, proximity to other vehicle's and their devices, etc. The telematics device may be configured to transmit the telematics data directly to the DCU 110. The DCU 110 may then format the telematics data and transmit it to the DPU 170. The DPU 170 may use a software based algorithm to analyze the telematics data to identify driving segments wherein each driving segment is associated with a driver signature. The DPU 170 may then categorize each signature as a known or unknown driver. Wherein the DPU 170, a signature with drivers listed on the insurance, may associate. The DPU 170 may further be configured to categorize unknown driver signatures as potentially impaired/distracted driving. The DPU 170 may compare the driver signatures with the expected drivers to determine the driver of a vehicle for each determined driving segment.

The system 100 may identify the driver based on the seat, mirror settings of the vehicle. The DPU 170 may identify the driver based on the route or destination in which the vehicle 140 is travelling (for example, based on the employment information, if the vehicle drives and parks for an extended time at an office, it may identify the driver.) Alternatively or additionally, if a user device 130 is connected with the vehicle 140 via BLUETOOTH, it may identify a phone number associated with the user device 130 and identify the driver based on that information. To further enhance this data, if the user device 130 is used for a phone call over the speaker phone, based on the location of the microphone that picks up the speech, the identification of the driver may be determined more accurately using voice recognition techniques.

Some vehicles 140 may automatically adjust the driving position based on an electronic key that is used for entry into the vehicle or to start the vehicle. The telematics device may be configured to identify the key used to activate the vehicle 140. Then, if the seat/vehicle setting remains the same, for example, the telematics device may transmit this information to the DCU 110, which then transmits the telematics data to the DPU 170 which is able to determine that the driver is the same as the registered or expected key owner. If the seat/vehicle settings are adjusted, then a DPU 170 may determine that a different driver is driving the vehicle 140.

In one embodiment, the DPU 170 may use the implicit driver identification, based on telematics data, to identify the number of unique driver signatures operating each vehicle and the amount of time each of the unique driving signatures are operating each vehicle including the vehicle driving or partially driving itself. The DPU 170 may use this information to determine the number and identity of drivers for each vehicle on the policy. The DPU 170 may communicate this information to the RPU 160, which may be configured to adjust the pricing information associated with the account. The pricing information may be adjusted, for example, by modifying the rate or rate category associated with the account or by providing a discount or penalty to the previous rate.

In another embodiment, the DPU 170 may be configured to access social media information associated with the drivers, and this information may be stored, for example on storage 192 associated with external servers 190. For example, the DPU 170 may receive data from an external server 190 associated with GOOGLE or FOURSQUARE or other similar application, which tracks an individual's location. The DPU 170 may be configured to compare the checked in location with the location of the vehicle 140 indicated by the telematics device and thereby identify the driver.

In another example of implicit driver identification, the DPU 170 may be configured to determine the driver based on the location of the vehicle 140. For example, if the vehicle 140 is driving to or parked at one of the insured's offices, the DPU 170 may identify the driver as a particular person.

The telematics device may be configured to transmit explicit driver identification information to the DCU 110. The vehicle 140 may be equipped, for example, with biometric readers that explicitly identify the driver. For example, to activate the vehicle 140, the driver may submit a fingerprint, retina sample, a voice sample or other similar biometric data. The telematics device may be configured to transmit this explicit identification information to the DCU 110.

The DCU 110 is configured to receive telematics data which is then formatted and sent to the DPU 170. The DPU 170 analyzes the information and clusters the time into segments. The segments may include time during which the vehicle 140 is being driven and time the vehicle 140 is parked. The DPU 170 may use telematics data and associate a driver or a driver signature with each driving segment. The RPU 160 may use the driver signature information in a number of ways to adjust the pricing information. The RPU 160 may be configured to assess risk associated with coverage without identifying the driver, and only the driving behavior. In this embodiment, the RPU 160 generates a risk assessment or profile, which may be based on the risk associated with insuring the vehicle based on the vehicle and the driver signatures.

An example of the telematics data, stored and transmitted by a telematics device is shown in Table 1, below. The telematics device may be configured to include an event/status monitor of the vehicle's 140 activities. An example of the event/status log, which may be stored in a database operatively coupled to the telematics device.

TABLE 1
Telematics Information Recorded

| | | | Radio | | | | | Turn |
|---|---|---|---|---|---|---|---|---|
| Time | Speed | Accel | Volume | Phone | Location | Brakes | Turning | Signal |
| 1:05 am | 76 | 4 | 8 | | 32605 | | | |
| 1:06 am | 86 | −6 | 8 | Y | 32605 | Y | | |
| 1:07 am | 54 | 30 | 8 | | 32606 | | | |
| 1:08 am | 86 | −2 | 9 | N | 32606 | Y | Y | N |
| 1:09 am | 52 | −30 | 9 | | 32606 | | | |

The telematics device may be configured to take periodic measurements regarding the vehicle, as well as event triggered measurements. For example, the telematics device may be configured to take readings every 1 second. The telematics device may be configured with different intervals for each measurement, for example, while speed may be reported every second, the radio volume may be reported each minute. The DCU 110 may be configured to receive this information and format the information to the specifications required by the DPU 170. Additionally, the telematics device may be configured to take readings based on event triggers, such as a detected turn, brake event, and phone activation, etc. The example above is not exhaustive; the metrics are shown as example only.

In another embodiment, the DPU 170 may be configured to determine when a braking event occurs. In this example, the DPU 170 may be configured to analyze speed and acceleration information to determine whether a braking event occurred. For example, if the acceleration telematics data is below a threshold, a braking event may be declared.

Similarly, if the positioning of the vehicle 140, relative to a determined center line of a road veers, the DPU 170 may determine a turn event, a lane change event, or impaired driving.

This information is received, by the DPU 170, which may then perform analysis to determine driver signatures.

Based on the type of plan, the RPU 160 may access the database 176 associated with the DPU 170 to determine risk and pricing information.

The RPU 160 may determine the pricing based on the percentage of time each vehicle is driven by a particular driver. The DPU 170 may associate each driving segment, based on the driver signature of that segment, with a driver. After associating each driving segment for a vehicle 140 with a driver, the DPU 170 then calculates percentages of vehicle driving time to apportion to each driver.

The system 100 uses the information provided in web page 1402 to generate an initial vehicle usage profile for each of the listed drivers including the vehicle itself. However, the telematics data, provided by the telematics device may be used to refine, replace, or adjust this information including replacing a proxy for autonomous feature usage with actual feature usage. The DPU 170 may use the information received from the DCU 110, to estimate the total use time for a vehicle 140. The system 100 categorizes each segment as being driven by a known driver (i.e. listed on the insurance) or an unknown driver (i.e. third party or impaired diver). Table 2, below shows an example of a usage chart generated by the system 100.

TABLE 2

| | Vehicle 1 | Vehicle 2 |
|---|---|---|
| John Doe | 80% | 10% |
| Jim Doe | 19% | 40% |
| Unknown Driver 1 | .5% | 50% |
| Unknown Driver 2 | .5% | 0% |

As shown in Table 2, above, the system 100 may be able to identify individual drivers. The unknown drivers may indicate that the vehicle 140 is being operated by an impaired driver, a distracted driver or unregistered driver. Additionally, it may indicate that the vehicle is being moved via a tow truck. Based on the received information, the DPU 170 may identify unique driver signatures and categorize the use of each vehicle. The DPU 170 may identify these driver signatures by clustering driving characteristics into segments using a multivariate analysis. The DPU 170 is configured to weight the information, based on the source (e.g. implicit driver identification, explicit driver identification). For example, if biometric readings provide explicit driver identification information, the likelihood of accurate driver identification is higher; it may therefore be weighted higher in the algorithm that determines the likely driver at each time. Implicit identification of a driver may be less accurate; accordingly each implicit identification may be weighted lower. For example, if Jim Doe is 6′8 and John Doe is 5′5, and the DPU 170 has access to seat adjustment information, it may compare the seat placement versus the height of the drivers. In this case the driver settings may provide a reliable indicator of the driver. However, braking, driver speed may be less likely an indicator in certain circumstances.

The RPU 160 may determine pricing information for the account, for example, based on an adjusted rate or a credit or penalty based on this information. For example, if the amount of driving segments that are identified as impaired, distracted or unregistered are above a predetermined threshold, the RPU 160 may determine that the pricing information should be adjusted.

The system 100 may further be configured to proactively adjust pricing information based on dropped high risk behavior. For example, if the DPU 170 determines that the amount of impaired, distracted or unregistered driving is below a predetermined threshold, or if the signature associated with a high risk driver improves or is reduced relative to one or more vehicles.

In another embodiment, the RPU 160 may assign risk, agnostic of the driver, based on the driving signatures. In this example, the RPU 160 requests data from the DPU 170 regarding the driving characteristics. Each use of the vehicle is categorized. For example, see Table 3 below:

TABLE 3

| | Vehicle 1 | Vehicle 2 |
|---|---|---|
| High Risk Use | 25% | 55% |
| Medium Risk Use | 25% | 35% |
| Low Risk Use | 50% | 10% |

Based on the amount of time the vehicle is driven in each risk category, the RPU 160 may determine pricing information without needing to identify the number of drivers or the identity of those drivers.

In one scenario, the system 100 may receive telematics data for a fixed time period. In this scenario, the RPU 160 may be configured to compensate for the limited duration of the telematics data using a seasonality factor. For example, if the telematics data is received from September-December, and the biographical information indicates one of the insured drivers attends college away from home, RPU 160 may be configured to use the seasonality factor to adjust the pricing information to account for the lack of information transmitted regarding that driver. Conversely, under the same scenario, if the readings were taken during the summer, when the student was home, the telematics data may be skewed the other way. Accordingly, the RPU 160 may use the seasonality factor to account for those differences.

The system 100 may further be configured to provide discounts outside typical renewal periods. For example, if an account includes a student driver and that student driver is associated with a high risk driver signature. If that student goes away to college, and the absence of high risk driver signature is measured for a predetermined period of time, then the system 100 may be configured to confirm that a driver has moved out and may offer an immediate discount.

In another embodiment, the system 100 may be configured to transmit the driver signature information to the customer. This may allow a customer to identify high risk driving behaviors and adjust the behaviors to lower their premium. This information may be accessible, for example, through web site system 120, or through an app loaded onto a user device 130.

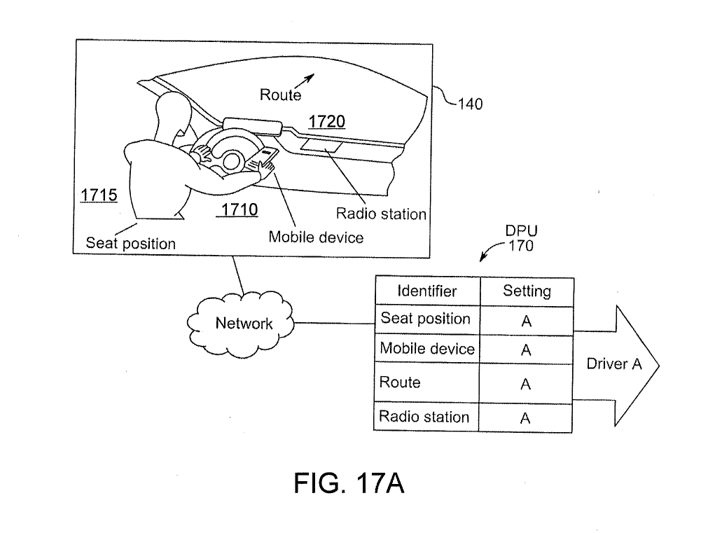

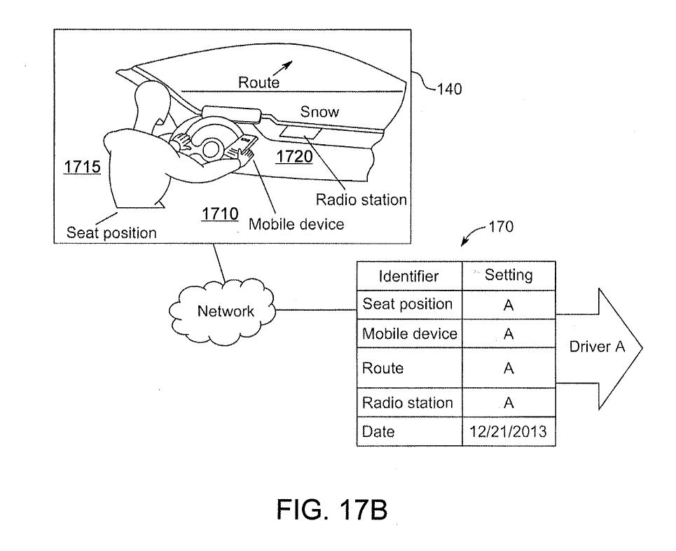

FIG. 17A shows an example configuration for determining a driver signature based on telematics data. As shown in FIG. 17, a driver is situated in the vehicle 140. The vehicle 140 includes an electronic seat adjustment unit 1715 and a radio 1720. The driver of the vehicle 140 also has a mobile device 1710. In this embodiment, the mobile device 1710 includes an app that enables it to operate as the telematics device. The mobile device 1710 may be connected to the vehicle 140 using a BLUETOOTH communications link. The mobile device 1710 receives seat position information, route information, radio station information, and other telematics data from the vehicle 140. The mobile device 1710 may communicate this information to a telematics collection server, such as the DCU 110. This information may be communicated continuously during the vehicle's 140 operation, or in another embodiment the mobile device 1710 may be configured to transmit the information at scheduled times, for example, when the mobile device 1710 is connected to a Wi-Fi network. The telematics collection server receives this information and may format the telematics data and send it to the DPU 170. The DPU 170 compares the received telematics data with preconfigured expected telematics values. As shown in FIG. 17A, the seat position information is compared with the expected seat position and it is determined that this is indicative of Driver A. The mobile device 1710 recording the information is determined to be indicative of Driver A. The route driven by vehicle 140 is indicative of Driver A. The use of radio 1720 is determined to be indicative of driver A. While in this example, each factor is indicative of driver A, in other examples, the seat position may be indicative of a Driver C and radio station may be indicative of a Driver B, by way of example. The DPU 170 may use a multivariate analysis to identify the driver of the vehicle 140 for a particular trip based on this received telematics information. Additionally, if all of the insured drivers are registered with the system 100, and if vehicle usage shows extended driving periods, not accounted for by the data transmitted by the mobile devices (e.g. 1710), the system 100 may determine the use is by an unregistered driver. In the example shown in FIG. 14A, the DPU 170 determines the driver to be driver A.

If the user is a potential customer, the user may provide or upload information from past experiences to the system 100. Or they may enroll to receive a trial telematics device prior to receiving an initial quote.

FIG. 17B shows an example configuration for determining a driver signature based on telematics data that accounts for a seasonality factor. As shown in FIG. 17B, the mobile device 1710 may be configured to communicate the telematics data as discussed in reference to FIG. 17A. In this example, telematics collection server may further be configured to communicate the date during which the vehicle was driven. This may be important, for example, if a student driver only drives 5% of the time, but that 5% of the time is during a snowy season. Additionally, as discussed above, the RPU 160 may incorporate a seasonality factor to compensate for expected changes in driving patterns during different times of year (e.g. different schedules during the school year.) The system 100 may be configured to use additional telematics data, for example, received from third party systems that may include weather data, traffic data, and other relevant data in compensating for seasonality.

Illustrative examples of the system 100 implementing driver signatures are shown below.

In a first scenario, the number of vehicles covered by the policy may include the number of listed drivers. Table 4 shows a driver proxy score below:

TABLE 4
Driver Proxy Score

| Assigned by Insurance rating | Assignment | Driver Proxy Score (1-50) |
|---|---|---|
| Vehicle 1 | Driver 1 | 30 |
| Vehicle 2 | Driver 2 | 45 |

In the example shown in Table 4, based on the information received from the customer, the assigned score is based on the expectation that vehicle 1 will be driven 100% by driver 1 and vehicle 2 will be driven 100% by driver 2.

However, the DPU 170 may receive telematics data to determine the actual miles driven by each driver. Table 5 below shows the determined actual miles driven.

TABLE 5
Actual Miles Driven, as determined by telematics data

| | Driver 1 | Driver 2 | |
|---|---|---|---|
| Vehicle 1 | 80% | 20% | 100% |
| Vehicle 2 | 20 | 80% | 100% |

The DPU 170 may be configured to generate a weighted average of driver score for vehicle 1 using driver signature=(percentage of time driven by driver 1)(driver proxy score)+(percentage of time driven by driver 2)(driver proxy score).

The DPU may further generate a weighted average of driver score for vehicle 2, for example, using as driver signature=driver signature=(percentage of time driven by driver 1)(driver proxy score)+(percentage of time driven by driver 2)(driver proxy score).

Based on this information, the DPU 170 determines a driver signature relativity for each vehicle=actual/expected.

The RPU 160 may use the driver signature relativity to determine pricing information. In one embodiment, the RPU 160 may generate a blended rate, based on the driver signature relativity. Additionally or alternatively, the RPU 160 may be configured to adjust the rate or provide a credit or penalty to the account.

In another scenario, the number of vehicles may be greater than the number of drivers.

Based on the customer provided biographical information, the DPU 170 may determine a driver proxy score for each vehicle. Table 6 shows an example of driver proxy scores in the scenario where there are more vehicles than drivers.

TABLE 6
Driver Proxy Scores when Vehicles > Drivers

| Assigned by | | |
|---|---|---|
| conventional rating | Assignment | Driver Proxy Score (1-50) |
| Vehicle 1 | Driver 1 | 30 |
| Vehicle 2 | Driver 2 | 40 |
| Vehicle 3 | Driver 2 | 40 |

Based on the information received during the registration phase (or alternatively on past experience), in the more cars than drivers (MCTD) scenario DPU 170 assigns a score based on an assumption that vehicle 3 will be driven 100% by driver 2, the worse of the two drivers. Table 7 shows the determined actual miles for each vehicle by each driver.

TABLE 7
Actual Miles Driven when Vehicles > Drivers

| | Driver 1 | Driver 2 | |
|---|---|---|---|
| | Miles Driven | Miles Driven | |
| Vehicle 1 | 80% | 20% | 100% |
| Vehicle 2 | 30% | 70% | 100% |
| Vehicle 3 | 50% | 50% | 100% |

Based on this information, the DPU 170 may determine the weighted average of driver score for vehicle 1 using driver signature=0.80*30+0.20*40.

The DPU 170 may determine the weighted average of driver score for Vehicle 2 using driver signature=0.30*30+0.70*40.

The DPU 170 may determine the weighted average of driver score for Vehicle 3 using driver signature=0.50*30+0.50*40.

The DPU 170 uses this information to determine a driver signature relativity adjustment for each vehicle=actual/expected.

The RPU 160 may use the driver signature relativity to determine pricing information. In one embodiment, the RPU 160 may generate a blended rate, based on the driver signature relativity. Additionally or alternatively, the RPU 160 may be configured to adjust the rate or provide a credit or penalty to the account.

The system 100 may further be configured to account for technologies such as “driverless car technology,” which may allow for autonomous operation of a vehicle, or aspects of a vehicle. The autonomous driver may be controlled by the vehicle's 140 control system. In one embodiment, the system 100 may be configured with a predetermined score for a driverless system. This may include scoring route selection patterns, braking patterns, accelerating patterns, and the speed, proportionality and accuracy of the vehicle's response to the environment, such as obstacles and changing conditions. The automated system would be treated as a unique driver with a particular signature attached. The system 100 may then be configured to account for the time a vehicle 140 is driven by a driverless vehicle system.

TABLE 8
Autonomous Vehicles

| | | |
|---|---|---|
| Assigned by | | |
| conventional rating | Assignment | Driver Proxy Score (1-30) |

| | | | |
|---|---|---|---|
| Vehicle 1 | Autonomous | 1 | (Perfect Driver Score) |
| Vehicle 1 | Driver 1 | 5 | (Good Driver Score) |
| Vehicle 1 | Driver 2 | 20 | (Bad Driver Score) |

An assigned score in the example of Table 8 assumes a vehicle 1 will autonomously operate itself, thereby earning a perfect driver proxy score (no accidents). However, driver 1 and driver 2 can assume operation of the vehicle. This would override autonomous capability and therefore the pricing calculation could be modified by a relativity factor. This factor would be calculated as follows for 80% autonomous driving, driver 1 15% driving, and driver 2 5% driving. Weighted average driver score for vehicle 1 using driver signature=0.80*1+0.15*5+0.05*20=2.55. Therefore, the driver signature relativity for vehicle 1 equals the actual/expected which is 2.55/1=2.55. This relativity factor can then be used in the calculation of the premium for vehicle 1.

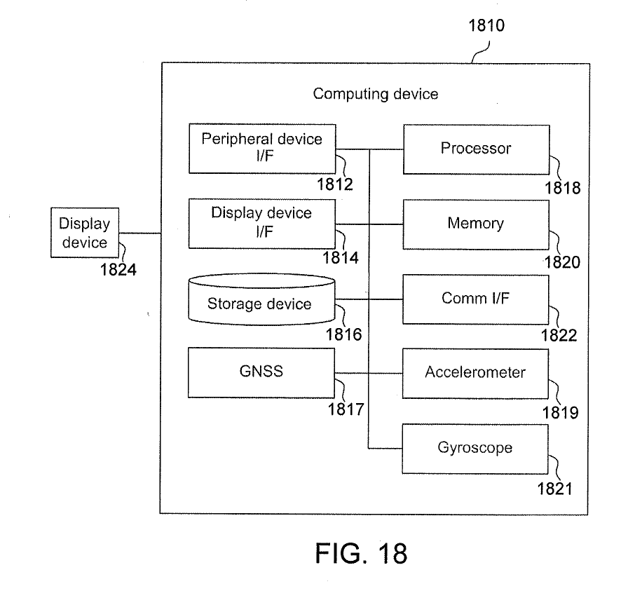

FIG. 18 shows an example computing device 1810 that may be used to implement features described above with reference to FIGS. 1-14. The computing device 1810 includes a global navigation satellite system (GNSS) receiver 1817, an accelerometer 1819, a gyroscope 1821, a processor 1818, memory device 1820, communication interface 1822, peripheral device interface 1812, display device interface 1814, and a storage device 1816. FIG. 18 also shows a display device 1824, which may be coupled to or included within the computing device 1810.

The system 100 may further include a user transmission device (not pictured) wherein the user transmission device may communicate insurance information, including pricing information, contractual information, information related to the telematics program, and other notifications. A user transmission device may include one or more modes of communication to reach a potential customer, current customer, or past customer or other similar user. For example, the user transmission device may be coupled with a printing device that is automatically mailed to the user. In another embodiment, the user transmission device may be coupled to a device to generate automatic telephone calls, or “robo-calls,” or other similar communication mediums to communicate with the user. The user transmission device may further be configured to send e-mails to a user. The user device may further be configured to communicate via social media.

The memory device 1820 may be or include a device such as a Dynamic Random Access Memory (D-RAM), Static RAM (S-RAM), or other RAM or a flash memory. The storage device 1816 may be or include a hard disk, a magneto-optical medium, an optical medium such as a CD-ROM, a digital versatile disk (DVDs), or BLU-RAY disc (BD), or other type of device for electronic data storage.

The communication interface 1822 may be, for example, a communications port, a wired transceiver, a wireless transceiver, and/or a network card. The communication interface 1822 may be capable of communicating using technologies such as Ethernet, fiber optics, microwave, xDSL (Digital Subscriber Line), Wireless Local Area Network (WLAN) technology, wireless cellular technology, BLUETOOTH technology and/or any other appropriate technology.

The peripheral device interface 1812 may be an interface configured to communicate with one or more peripheral devices. As an example, the peripheral device may communicate with an on-board diagnostics (OBD) unit that is associated with a vehicle. The peripheral device interface 1812 may operate using a technology such as Universal Serial Bus (USB), PS/2, BLUETOOTH, infrared, serial port, parallel port, and/or other appropriate technology. The peripheral device interface 1812 may, for example, receive input data from an input device such as a keyboard, a mouse, a trackball, a touch screen, a touch pad, a stylus pad, and/or other device. Alternatively or additionally, the peripheral device interface 1812 may communicate output data to a printer that is attached to the computing device 1810 via the peripheral device interface 1812.

The display device interface 1814 may be an interface configured to communicate data to display device 1824. The display device 1824 may be, for example, an in-dash display, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1814 may operate using technology such as Video Graphics Array (VGA), Super VGA (S-VGA), Digital Visual Interface (DVI), High-Definition Multimedia Interface (HDMI), or other appropriate technology. The display device interface 1814 may communicate display data from the processor 1818 to the display device 1824 for display by the display device 1824. As shown in FIG. 18, the display device 1824 may be external to the computing device 1810, and coupled to the computing device 1810 via the display device interface 1814. Alternatively, the display device 1824 may be included in the computing device 1810.

An instance of the computing device 1810 of FIG. 18 may be configured to perform any feature or any combination of features described above as performed by the user device 130. In such an instance, the memory device 1820 and/or the storage device 1816 may store instructions which, when executed by the processor 1818, cause the processor 1818 to perform any feature or any combination of features described above as performed by the web browser module 132. Alternatively or additionally, in such an instance, each or any of the features described above as performed by the web browser module 132 may be performed by the processor 1818 in conjunction with the memory device 1820, communication interface 1822, peripheral device interface 1812, display device interface 1814, and/or storage device 1816.

Although FIG. 18 shows that the computing device 1810 includes a single processor 1818, single memory device 1820, single communication interface 1822, single peripheral device interface 1812, single display device interface 1814, and single storage device 1816, the computing device may include multiples of each or any combination of these components, and may be configured to perform, mutatis mutandis, analogous functionality to that described above.

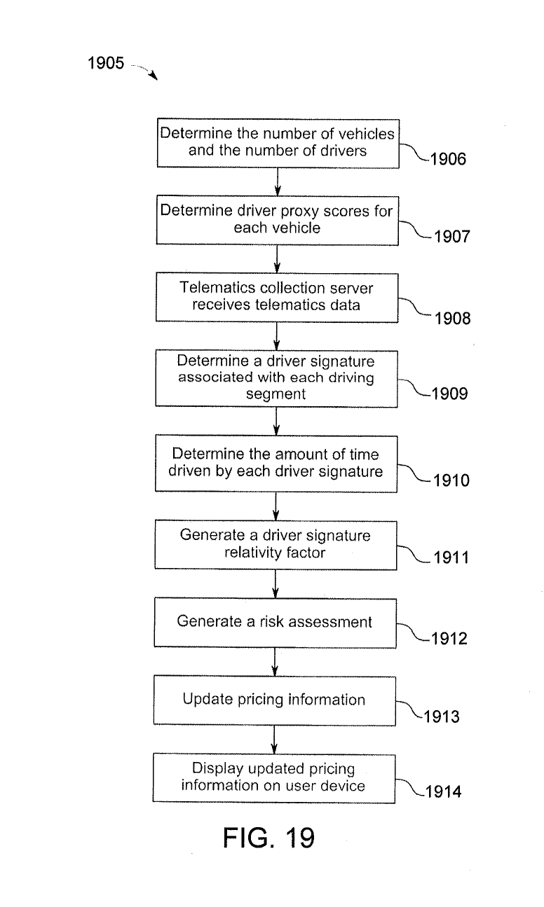

FIG. 19 shows a flow diagram for a method 1905 for determining driver signatures associated with vehicle use and updating pricing information based on the determined driver signatures. Because the insurance company may employ a different analysis based on the number of cars relative to the number of drivers, the system 100 may determine the number of vehicles and the number of drivers (step 1906). Based on the number of vehicles and the number of drivers and the expected use of each vehicle, the DPU 170 may determine a driver proxy score for each vehicle (step 1907). A telematics collection server may then receive telematics data associated with each vehicle (step 1908). The telematics collection server may be operated by the insurance company or it may be operated by a third party service. An example of a telematics collection server is the DCU 110. For each segment during which a vehicle is driven, the DPU 170 may analyze the telematics data to determine a driver signature associated with each segment (step 1909). The DPU 170 may determine the amount of time each vehicle was driven by each driver signature (step 1910). Based on this information, the DPU 170 may generate a driver signature relativity factor for each vehicle (step 1911). The driver signature relativity factor may account for the driver proxy score for each vehicle verses the values determined based on driver signatures. The RPU 160 generates a risk assessment based on the driver signature relativity factor (step 1912). In one embodiment, the risk assessment may include vehicle profiles which comprise the total number of drivers and the behavior of each of those drivers. The RPU 160 may then generate updated pricing information based on the risk assessment (step 1913). The website system 120 may communicate the updated pricing information to a user device 130 (step 1914). The website system 120 may further communicate suggested changes in driving behavior that may be used to receive a discount.

The multivariate predictive model(s) that may be used in determining pricing information may include one or more of neural networks, Bayesian networks (such as Hidden Markov models), expert systems, decision trees, collections of decision trees, support vector machines, or other systems known in the art for addressing problems with large numbers of variables. In embodiments, the predictive models are trained on prior data and outcomes using an historical database of insurance related data and resulting correlations relating to a same user, different users, or a combination of a same and different users. The predictive model may be implemented as part of the DPU 170 or RPU 160 described with respect to FIG. 1. The system 100 may be used in combination with an insurance class plan or may be used independent of insurance class plans.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or BLURAY-DISC, or other type of device for electronic data storage.

Although the methods and features described above with reference to FIGS. 2-19 are described above as performed using the example system 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-19 may be used alone without the other features and elements or in various combinations with or without other features and elements. Sub-elements of the methods and features described above with reference to FIGS. 1-19 may be performed in any arbitrary order (including concurrently), in any combination or sub-combination.

What is claimed is:

1. A system configured to determine a premium associated with an account that covers at least one vehicle including at least one autonomous feature, the system comprising:
a computer memory that stores biographical information at least including information regarding the at least one autonomous feature;
a processor that receives information associated with telematics data associated with at least one of the vehicle(s), concerning use of the at least one autonomous feature;
the processor further configured to generate a vehicle signature relativity responsive to the received information and the stored biographical information;
the processor further configured to calculate pricing information based at least in part on the vehicle signature relativity; and
a transmitter configured to transmit the pricing information to a user device.

2. The system of claim 1, wherein the processor calculates a weighted average driver score for the vehicle using a driver proxy score for each driver and the percentage of the time that each driver operates the vehicle.

3. The system of claim 2, wherein the weighted average driver score is the actual score for the vehicle.

4. The system of claim 3, wherein the driver signature relativity for the vehicle is based on a comparison of the actual score for the vehicle and the expected score for the vehicle.

5. The system of claim 2, wherein the percentage of the time that each driver operates the vehicle is determined from the received information.

6. The system of claim 1, wherein the at least one autonomous feature includes a perfect driver score.

7. The system of claim 1, wherein the at least one autonomous feature is identified using the VIN.

8. A method, implemented in a computer system, for determining an premium associated with an account that covers at least one vehicle including at least one autonomous feature and at least one driver, the method comprising:
storing, by a computer memory, biographical information associated with at least including information regarding the at least one autonomous feature;
receiving, by a processor, information associated with telematics data, wherein the telematics data is associated with at least one of the vehicle(s), the telematics data providing information concerning use of the at least one autonomous feature;
generating, by the processor, a vehicle signature relativity responsive to the received information and the stored biographical information;
calculating, by the processor, pricing information based at least in part on the vehicle signature relativity; and
transmitting, by a transmitter, the pricing information to a user device

9. The method of claim 8, further comprising calculating a weighted average driver score for the vehicle using a driver proxy score for each driver and the percentage of time that each driver operates the vehicle as determined using the received information.

10. The method of claim 9, wherein the weighted average driver score is the actual score for the vehicle.

11. The method of claim 10, wherein the driver signature relativity for the vehicle is based on a comparison of the actual score for the vehicle and the expected score for the vehicle.

12. The method of claim 8, further comprising determining, by the processor, a percentage of time each of the at least one autonomous features are activated.

13. The method of claim 12, further comprising determining, by the processor, a percentage of time each of the at least one autonomous features are used.

14. The method of claim 8, further comprising adjusting, by the processor, the pricing information based at least in part on autonomous operation of the vehicle.

15. The method of claim 8, wherein the at least one autonomous feature includes a perfect driver score.

16. The method of claim 8, further comprising determining the percentage of time that each driver operates the vehicle as determined using the received information.

17. The method of claim 9, wherein the at least one autonomous feature is identified using the VIN.

18. A system configured to determine an premium associated with an account that covers at least one vehicle and at least one autonomous driver, the system comprising:
a computer memory configured to store biographical information associated with at least one driver;
a processor configured to receive information associated with telematics data, wherein the telematics data is associated with at least one of the vehicles, the telematics data providing information concerning use of the at least one vehicles;
the processor further configured to generate a vehicle signature responsive to the received information and the stored biographical information;
the processor further configured to calculate pricing information based at least in part on the vehicle signature; and
a transmitter configured to transmit the pricing information to a user device.

19. The system of claim 18, wherein the processor calculates a weighted average driver score for the vehicle using a driver proxy score for each driver and the percentage of the time that each driver operates the vehicle.

20. The system of claim 19, wherein the driver signature relativity for the vehicle is based on a comparison of the average driver score for the vehicle and the expected score for the vehicle.
